(19) United States
(12) Patent Application Publication
(10) Pub. No.: US 2019/0085806 A1
(43) Pub. Date: Mar. 21, 2019

(54) Valve For A High-Pressure Pump For A Motor Vehicle

(71) Applicant: Continental Automotive GmbH, Hannover (DE)

(72) Inventors: Henry Meißgeier, Roding (DE); Andreas Mühlbauer, Bernhardswald (DE); Bernd Wöllisch, Chamerau (DE)

(73) Assignee: Continental Automotive GmbH, Hannover (DE)

(21) Appl. No.: 16/130,337

(22) Filed: Sep. 13, 2018

(30) Foreign Application Priority Data
Sep. 20, 2017 (DE) 10 2017 216 626.6

(51) Int. Cl. F02M 59/36; F02M 63/00; F02M 59/46; F16K 27/02

(52) U.S. Cl. CPC F02M 59/367; F02M 63/0017; F16K 27/0209; F02M 63/0031; F02M 59/466

(57) ABSTRACT

Some embodiments may include a valve for a pump comprising: a first stop element having a longitudinal axis and a sealing seat; an actuator providing an actuator force along the longitudinal axis; a pin movable relative to the first stop element along the longitudinal axis and movable by the actuator force; a sealing element moved by the pin relative to the valve seat in order to open or close the valve; and a second stop element rigidly fastened to the first stop element providing a stop for the sealing element to limit movement of the sealing element away from the sealing seat along the longitudinal axis. The second stop element is fastened at a defined predetermined distance from the first stop element to define a spacing between the sealing seat and the stop.

### CROSS-REFERENCE TO RELATED APPLICATIONS

This application claims priority to DE Application No. 10 2017 216 626.6 filed Sep. 20, 2017, the contents of which are hereby incorporated by reference in their entirety.

### TECHNICAL FIELD

The present disclosure relates to motor vehicles and other applications requiring valves. Various embodiments may include a valve for a high-pressure pump for a motor vehicle, in particular a valve for a pump for conveying fluid for an injection system for internal combustion engines of motor vehicles.

### BACKGROUND

Fuel injection systems for internal combustion engines may have a high-pressure pump which conveys fluid, in particular gasoline or diesel, from a fluid tank to injection valves of the internal combustion engine. Manufacturing tolerances for these valves may have repercussions on the accuracy of the valves.

### SUMMARY

In some embodiments, a valve for a high-pressure pump for a motor vehicle has a first stop element with a longitudinal axis and with a sealing seat. The valve has an actuator with an actuator force that can be caused to act along the longitudinal axis. The valve has a pin which is movable relative to the first stop element along the longitudinal axis. The pin is actuatable by means of the actuator. The valve has a sealing element. The valve is movable by the pin relative to the valve seat in order to open or close the valve. The valve has a second stop element. The second stop element is rigidly fastened to the first stop element. The second stop element has a stop for the sealing element. The stop limits movement of the sealing element away from the sealing seat along the longitudinal axis. The second stop element is fastened in a definedly predetermined position to the first stop element. The sealing seat and the stop have a definedly predetermined spacing to one another.

As an example, some embodiments may include a valve (100) for a high-pressure pump (101) for a motor vehicle, having: a first stop element (102) with a longitudinal axis (104) and a sealing seat (118), an actuator (105) with an actuator force (106) that can be caused to act along the longitudinal axis (104), a pin (107) which is movable relative to the first stop element (102) along the longitudinal axis (104) and which is actuatable by means of the actuator (105), a sealing element (108) which is movable by the pin (107) relative to the valve seat (118) in order to open or close the valve (100), and a second stop element (103) which is rigidly fastened to the first stop element (102) and which has a stop (109) for the sealing element (108) in order to limit a movement of the sealing element (108) away from the sealing seat (118) along the longitudinal axis (104), wherein the second stop element (103) is fastened in a definedly predetermined position to the first stop element (102), such that the sealing seat (118) and the stop (109) have a definedly predetermined spacing (110) to one another.

In some embodiments, the second stop element (103) is a sleeve (111), and a side wall (112) of the sleeve (111) is fastened to the first stop element (102), and the stop (109) is formed on a base region (113), which runs transversely with respect to the side wall (112), of the sleeve (111).

In some embodiments, the first stop element (102) has a groove (114) in which the second stop element (103) is partially arranged.

In some embodiments, the sealing element (108) has a disk-shaped form, and a surface (116), facing toward the sealing seat (118), of the sealing element (108) has a definedly predetermined intermediate space (117) with respect to the sealing seat (118) when the sealing element (108) is in contact with the stop (109).

As another example, some embodiments may include a method for producing a valve (100) for a high-pressure pump (101) for a motor vehicle, comprising: providing a first stop element (102), which has a longitudinal axis (104) and a sealing seat (118), an actuator (105), which has an actuator force (106) that can be caused to act along the longitudinal axis, a pin (107), a sealing element (108), and a second stop element (103), which has a stop (109) for the sealing element (108), arranging the pin (107) partially in the first stop element (102), such that the pin (107) is movable relative to the first stop element (102) along the longitudinal axis (104) and is actuatable by means of the actuator (105), arranging the sealing element (108) between the first stop element (102) and the second stop element (103), such that the sealing element (108) is movable by the pin (107) relative to the sealing seat (118) in order to open or close the valve (100), displacing the first stop element (102) and the second stop element (103) relative to one another along the longitudinal axis (104) and thus varying a spacing between the sealing seat (118) and the stop (109), and fixing the second stop element (103) to the first stop element (102) when the spacing corresponds to a definedly predetermining spacing (110).

Some embodiments further include: pushing the sealing element (108) against the stop (109) during the displacement, varying an intermediate space between the sealing element (108) and the sealing seat (108) by means of the displacement, and fixing the second stop element (103) to the first stop element (102) when the intermediate space corresponds to a definedly predetermining intermediate space (117).

In some embodiments, the fixing comprises at least one of the following: welding, adhesive bonding, brazing, and pressing.

Some embodiments further include predetermining the definedly predetermining spacing (110) by means of a gauge (121).

In some embodiments, the provision of the first stop element (102) and/or of the second stop element (103) comprises injection-molding a metal.

### BRIEF DESCRIPTION OF THE DRAWINGS

Further advantages, features, and developments can be gathered from the following examples which are explained in conjunction with the figures. Elements that are identical, of identical type, and/or of identical action may be provided with the same reference signs in said figures.

In the figures:

FIG. 1 shows a schematic illustration of a valve according to the teachings herein;

FIG. 2 shows a schematic illustration of a detail of the valve according to the teachings herein; and

FIG. 3 shows a flow diagram of a production method according to the teachings herein.

### DETAILED DESCRIPTION

In some embodiments, a valve may comprise an inlet valve for a high-pressure pump, a volume flow control valve, or some other valve that is used in a fuel injection system with a high-pressure pump. In some embodiments, two stop elements limit the movement of the sealing element along the longitudinal axis in both directions and are two separate components. The two stop elements are fastened to one another in the definedly predetermined position, such that the definedly predetermined spacing is maintained. The definedly predetermined spacing is measured during the assembly of the valve. Thus, production tolerances of the two stop elements are compensated and have no or little effect on the limitation of the movement of the sealing element. For example, the two stop elements are connected to one another by means of a joining process. In some embodiments, the two stop elements have a common welded connection, a common adhesive connection, a common brazed connection, a common press-fit connection, and/or some other type of connection that reliably connects the two stop elements to one another at the definedly predetermined position.

In some embodiments, the movement of the sealing element between the sealing seat and the stop along the longitudinal axis, also referred to as valve stroke, has a tolerance defined by the accuracy of the setting process of the definedly predetermined position or the definedly predetermined spacing. The tolerances of the individual components, in particular of the two stop elements, are negligible.

In some embodiments, the second stop element is a sleeve. A side wall of the sleeve may be fastened to the first stop element. The stop is formed in a base region of the sleeve. The base region runs transversely with respect to the side wall and in particular also transversely with respect to the longitudinal axis. Use can thus be made of a component with a relatively simple geometry. The first and/or the second stop element are in each case composed in particular of high-grade steel. For example, the second stop element is a punched and bent part and/or is produced by means of metal injection molding.

In some embodiments, the first stop element has a groove in which the second stop element is partially arranged. The groove permits the displacement of the second stop element relative to the first stop element during the assembly process. Furthermore, the groove permits a fastening of the second stop element to the first stop element in different positions, such that the definedly predetermined spacing is maintained.

In some embodiments, the sealing element has a disk shape. In particular, the sealing element has an areal disk-shaped extending transversely with respect to the longitudinal axis. A surface, facing toward the sealing seat, of the sealing element has a definedly predetermined intermediate space with respect to the sealing seat when the sealing element is in contact with the stop. A maximum opening cross section through which the fluid can pass between the sealing seat and the surface of the sealing element is thus predetermined. This maximum opening cross section is independent of the tolerances of the components of the definedly predetermined intermediate space.

In some embodiments, the valve is used as an inlet valve of a high-pressure gasoline pump. The high-pressure gasoline pump is designed for example to provide pressures from 200 bar up to 500 bar or higher.

In some embodiments, a method for producing a valve for a high-pressure pump for a motor vehicle comprises providing a first stop element, which has a longitudinal axis and a sealing seat. An actuator is provided, which has an actuator force that can be caused to act along the longitudinal axis. A pin, a sealing element and a second stop element, which has a stop for the sealing element, are provided. The pin is arranged partially in the first stop element, such that the pin is movable relative to the first stop element along the longitudinal axis and is actuatable by means of the actuator. The sealing element is arranged between the first stop element and the second stop element, such that the sealing element is movable by the pin relative to the sealing seat in order to open or close the valve. The first stop element and the second stop element are displaced relative to one another along the longitudinal axis. In this way, a spacing between the sealing seat and the stop is varied. The second stop element is fixed to the first stop element when the spacing corresponds to a definedly predetermining spacing. Thus, the spacing between the sealing seat and the stop is always set to a definedly predetermined value, regardless of tolerances of the components. The tolerances of the components, which arise for example during the production of the components, are compensated by means of the method according to the application and have in particular no effect, or only little effect, on the spacing between the sealing seat and the stop.

In some embodiments, a valve according to discussed above is produced by means of the method.

In some embodiments, the sealing element is pushed against the stop during the displacement. An intermediate space between the sealing element and the sealing seat is varied by means of the displacement. The second stop element is fixed to the first stop element when the intermediate space corresponds to a definedly predetermining intermediate space. Thus, the maximum available opening cross section between the sealing seat and the sealing element, in particular a surface of the sealing element facing toward the sealing seat, is set to the definedly predetermined value independently of the tolerances of the components. For example, the definedly predetermined spacing and/or the definedly predetermined intermediate space is predetermined by means of a gauge. The gauge is arranged between the two stop elements and/or between the sealing element and the first stop element during the displacement in order to definedly predetermine the definedly predetermined spacing and/or the definedly predetermined intermediate space.

In some embodiments, the fixing of the second stop element to the first stop element comprises welding, adhesive bonding, brazing, pressing, and/or some other connecting method.

In some embodiments, the first stop element is produced by means of injection molding of a metal. In some embodiments, the second stop element is produced by means of injection molding of a metal. In some embodiments, the metal comprises a high-grade steel. In some embodiments, the first stop element and/or the second stop element are produced by means of punching and bending.

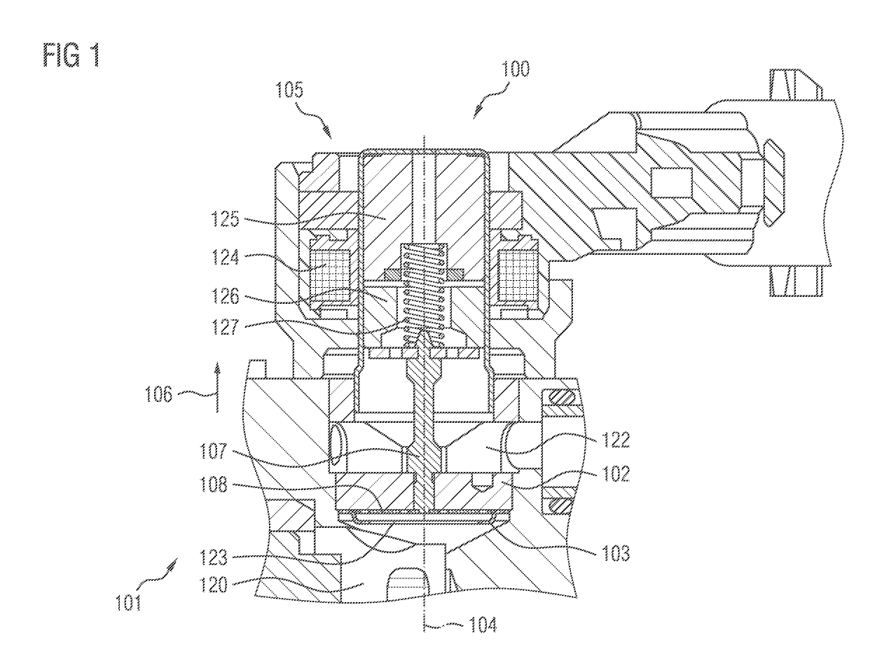

FIG. 1 shows a schematic illustration of a valve 100 according to the teachings herein. The valve 100 as per the illustrated exemplary embodiment is used as an inlet valve of a high-pressure pump 101 of a fuel delivery system for gasoline. Other uses of the valve 100 are also possible, for example as a volume flow control valve, and/or as a pressure control valve. The high-pressure pump 101 pumps a fuel such as gasoline or diesel from a fuel tank to an internal combustion engine of a motor vehicle. For example, the fuel is injected by means of injectors into combustion chambers of the internal combustion engine.

The valve 100 meters fluid into a conveying chamber 120 of the high-pressure pump 101. When the valve 100 is open, a fluid flow from an inlet 122, facing toward the fluid tank, to an outlet 123, facing toward the conveying chamber 120, is possible. The valve 100 may be held open counter to the delivery pressure of the high-pressure pump 101, such that a fluid flow out of the delivery chamber 120 through the valve 100 in the direction of the fuel tank is also possible.

The valve 100 has an actuator 105. In some embodiments, the actuator 105 comprises an electromagnetic actuator. The actuator 105 imparts an actuator force 106 along a longitudinal axis 105. The actuator 105 includes a coil 124 that can have an electrical current applied thereto. The actuator 105 furthermore has a pole core 125 which is arranged in the interior of the coil 124. An armature 126 is movable relative to the pole core 125 along the longitudinal axis 104.

In some embodiments, the valve 100 is a switching valve, comprising a combination of the actuator 105 and a hydraulic arrangement that is switched by means of the actuator 105. In terms of function, it is for example the case that two switching states of the hydraulic arrangement are realized: an open position and a closed position.

In the case of the actuator 105, the pole core 125 and the armature are held spaced apart in the electrically deenergized state by an actuator spring 127. The electrical energization of the coil 124 with electrical current causes a magnetic field to be built up in the coil 3. This magnetic field is induced in the surrounding metal components, such that the actuator force 106 is built up between the armature 126 and the pole core 125. The spring force of the actuator spring 127, e.g. a compression spring, is overcome by the actuator force 106. The actuator force 106 is transmitted to a pin 107 of the valve 100, and the hydraulics are thus controlled.

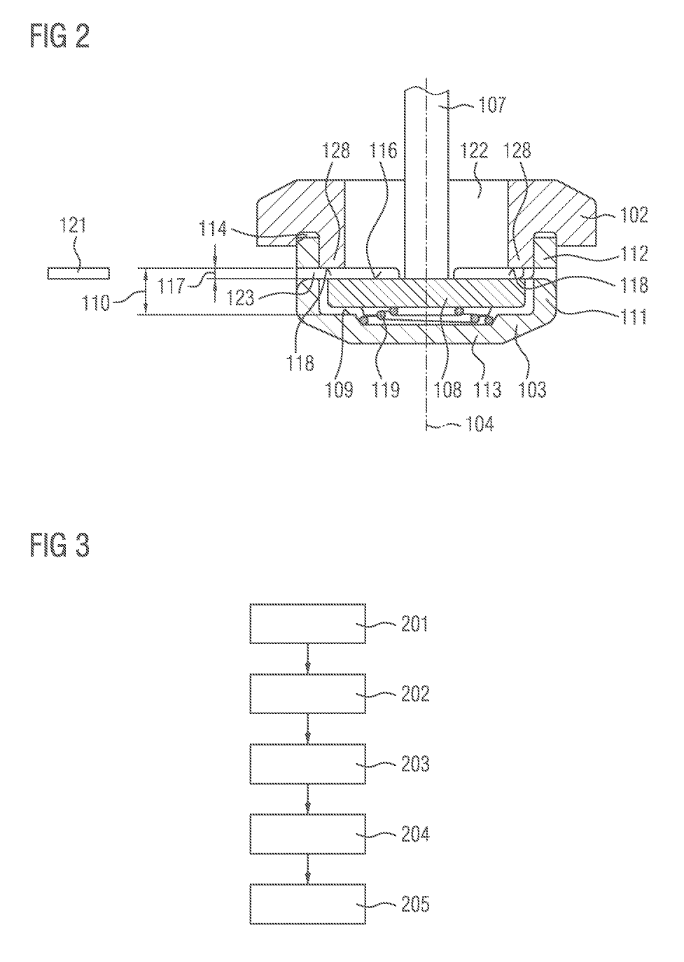

FIG. 2 shows a schematic illustration of a detail of the valve 100, which can also be referred to as hydraulics or passive unit. The valve 100 has a first stop element 102. The stop element 102 faces toward the actuator 105 along the longitudinal axis 104. The valve 100 has a second stop element 103. The second stop element 103 faces toward the conveying chamber 120 in the operationally ready state. The first stop element 102 is arranged between the actuator 105 and the second stop element 103 along the longitudinal axis 104.

The first stop element 102 is of ring-shaped form. The first stop element 102 has a sealing seat 118 at a side averted from the actuator 105. The second stop element 103 has the form of a sleeve 111. A side wall 112, which is oriented substantially along the longitudinal axis 104, is in contact at least in regions with the first stop element 102. A base region 113 of the second stop element 103 is oriented transversely with respect to the longitudinal axis 104 and closes off the second stop element 103 in the direction of the conveying chamber 120 in the operationally ready state. A stop 109 is formed on the base region 113. The stop 109 faces, in particular, toward the first stop element 102. For example, the stop 109 is formed by means of a step, a projection or some other geometry.

A disk-shaped sealing element 108 sits between the sealing seat 118 and the stop 109 along the longitudinal axis 104. When the sealing element 108 bears against the sealing seat 118, a fluid flow through the valve 100 is in particular shut off. To enable the fluid flow through the valve 100, the sealing element 108 is, for example by means of the actuator force 106, arranged spaced apart from the sealing seat 118. Fluid can pass through the intermediate space between the sealing seat 118 and a surface 116, facing toward the sealing seat 118, of the sealing element 108 to the outlet 123.

In some embodiments, a spring 119 is arranged between the base region 113 and the sealing element 108. The spring 119 pushes the sealing element 108 against the sealing seat 118 along the longitudinal axis 104 in the direction of the actuator 105. The first stop element 102 and the second stop element 103 are coupled to one another in the region of the side wall 112 of the second stop element 103 and in the region of a groove 114 of the first stop element 102. The groove 114 may have a ring-shaped form around the longitudinal axis 104 and open in a direction away from the actuator 104. Thus, the first stop element 102 has a ring-shaped projection 128 which delimits the groove 114 to the inside. The projection 128, which extends along the longitudinal axis 104, and the side wall 112, which is oriented along the longitudinal axis 104, are in contact with one another. A connection produced by means of joining technology fixes the second stop element 103 to the first stop element 102.

The second stop element 103 is fixed to the first stop element 102 in a definedly predetermined position relative to the first stop element 102. In particular, the position is predetermined by a definedly predetermined spacing 110 between the sealing seat 118 and the stop 109. Alternatively or in addition, the position is predetermined by a definedly predetermined intermediate space 117 between the surface 116 and the sealing seat 118 when the sealing element 108 is positioned, along the longitudinal direction, in its position spaced apart to a maximum extent from the actuator 105.

During the production process, to maintain the definedly predetermined intermediate space 117 and/or the definedly predetermined spacing 110, use is made for example of a gauge 121. Before the second stop element 103 is fixedly connected to the first stop element 102, the definedly predetermined spacing 110 and/or the definedly predetermined intermediate space 117 is set by means of the gauge 121. Then, the first stop element 102 and the second stop element 103 are rigidly connected to one another, such that the definedly predetermined spacing 110 and/or the definedly predetermined intermediate space 117 for the valve 100 is set.

In some embodiments, the gauge 121 predetermines a spacing between the surface 116 of the sealing element 108 and a top side, averted from the sealing element 108 along the longitudinal axis 104, of the first stop element 102. This is possible in particular if the first stop element 102 is a turned part manufactured with very high precision, and the sealing seat 118 is for example ground.

The valve 100 permits an exact setting of the limitation of the axial movement of the sealing element 108 along the longitudinal axis 104, also referred to as valve stroke. The sealing element 108 is movable axially between the stop 109 and the sealing seat 118. In the case of the valve 100 according to the application, the maximum axial movement of the sealing element 108 is not influenced primarily by the manufacturing process, and in particular does not vary owing to the manufacturing of the individual components. Production-induced tolerances of the components, in particular of the two stop elements 102, 103 and/or of the sealing element 108, are compensated through the setting of the predefined spacing 110 and/or of the predefined intermediate space 117 for example by means of the gauge 121. It is thus possible to omit an additional tolerance reserve in the magnetic stroke. Furthermore, it is possible to omit an additional stop for example on the pin 107. The stroke of the sealing element 108 is settable by means of the groove 114 and the sleeve 111, in particular by means of the relative position of the two stop elements 102 and 103 with respect to one another.

FIG. 3 shows a flow diagram of a production method for the valve 100 according to the teachings herein.

In step 201, the actuator 105, the pin 107, the first stop element 102, the second stop element 103, and the sealing element 108 are provided. For example, the first stop element 102 and/or the second stop element 103 are produced by means of so-called MIM (metal injection molding). In this way, it is in particular also possible to produce complex geometries for the two stop elements 102, 103. This is economical in particular if large unit quantities are being produced. In some embodiments, the first stop element 102 and/or the second stop element 103 are produced by means of punching and bending. In particular, the first stop element 102, the second stop element 103 and the sealing element 108 are each manufactured from a high-grade steel.

In step 202, the pin is arranged partially in the first stop element 102. The pin 107 may be oriented along the longitudinal axis 104 and movable relative to the stop element 102. For example, the pin 107 is coupled to the actuator 105, such that the actuator force 106 and/or the spring force of the spring 127 are transmitted to the sealing element 108.

In a step 203, the sealing element 108 is arranged between the first stop element 102 and the second stop element 103. The sealing element 108 may be arranged between the sealing seat 118 and the stop 109.

In a step 204, the first stop element 102 and the second stop element 103 are displaced relative to one another along the longitudinal axis 104. The two stop elements 102, 103 are displaced relative to one another such that a spacing between the sealing seat 118 and the stop 109 changes. For example, the gauge 121 is predetermined to predetermine the spacing between the sealing seat 118 and the stop 109. The two stop elements 102, 103 are displaced relative to one another until the spacing between the sealing seat 118 and the stop 109 corresponds to the definedly predetermined spacing 110, which is predetermined for example by the gauge 121.

In a step 205, the second stop element 103 is subsequently fixed to the first stop element 102 in the predetermined position, which corresponds to the predetermined spacing 110.

In some embodiments, in step 204, an intermediate space between the sealing seat 118 and the surface 116 of the sealing element 108 is varied until the intermediate space corresponds to the definedly predetermined intermediate space 117, which is predefined for example by means of the gauge 121.

The accuracies of the production method thus predetermine the tolerance of the stroke of the sealing element 108, that is to say in particular the tolerance of the spacing 110 and/or of the intermediate space 117. It is thus possible for tolerances of the components that arise for example during the production process to be compensated. The stroke of the sealing element 108 is in particular independent, or independent to the greatest possible extent, of production tolerances of the components.

The production method as per FIG. 3 may be inexpensive. For example, the individual components can be produced with more greater production tolerances. This, too, leads to a reduction of the component costs. The greater individual tolerances of the components are compensated by means of the method according to the application. Furthermore, there is in particular no need for a relatively large tolerance reserve to be provided in the actuator 105 and in particular in the electromagnet. Thus, the actuator 105 and in particular the electromagnet can be designed to be smaller. A cost saving can be achieved in this way. Furthermore, a smaller structural space is possible. In the case of a multiplicity of valves 101 being produced, the variances between the individual valves 101 are reduced, because the switching times of the valves 100 exhibit less variance. The switching time of a valve 100 is influenced directly by the stroke of the sealing element 108. Furthermore, the pressure drop fluctuations across the valve 100 are smaller; in particular, if said valve is used as an inlet valve in the fuel pump 101, the filling characteristic exhibits less fluctuation. In this way, the valve 100 can be designed to be smaller overall.

In some embodiments, the valve 100 is open when electrically deenergized. In some embodiments, the valve 100 is designed as a valve which is closed when electrically deenergized.

1. A valve for a pump, the valve comprising:
a first stop element having a longitudinal axis and a sealing seat;
an actuator providing an actuator force along the longitudinal axis;
a pin movable relative to the first stop element along the longitudinal axis and movable by the actuator force;
a sealing element moved by the pin relative to the valve seat in order to open or close the valve; and
a second stop element rigidly fastened to the first stop element providing a stop for the sealing element to limit movement of the sealing element away from the sealing seat along the longitudinal axis;
wherein the second stop element is fastened at a defined predetermined distance from the first stop element to define a spacing between the sealing seat and the stop.

2. The valve as claimed in claim 1, wherein:
the second stop element comprises a sleeve;
a side wall of the sleeve is fastened to the first stop element; and
the stop is formed on a base region of the sleeve which runs transversely with respect to the side wall.

3. The valve as claimed in claim 1, wherein the first stop element has a groove in which the second stop element is at least partially arranged.

4. The valve as claimed in claim 1, wherein the sealing element comprises a disk with a surface facing toward the sealing seat and defines an intermediate space with respect to the sealing seat when the sealing element is in contact with the stop.

5. A method for producing a valve for a pump, the method comprising:
assembling a first stop element with a longitudinal axis and a sealing seat with an actuator applying an actuator force along the longitudinal axis, and a second stop element with a stop for the sealing element;
arranging a pin partially in the first stop element to move relative to the first stop element along the longitudinal axis in response to the actuator force;
arranging a sealing element between the first stop element and the second stop element so the sealing element moves in response to movement of the pin relative to the sealing seat in order to open or close the valve;
displacing the first stop element and the second stop element relative to one another along the longitudinal axis to define a spacing between the sealing seat and the stop; and
fixing the second stop element to the first stop element when the spacing corresponds to a predetermined spacing.

6. The method as claimed in claim 5, further comprising:
pushing the sealing element against the stop during the displacement;
varying an intermediate space between the sealing element and the sealing seat by means of the displacement; and
fixing the second stop element to the first stop element when the intermediate space corresponds to a predetermined intermediate space.

7. The method as claimed in claim 5, wherein fixing the second stop element to the first stop element includes at least one of the following: welding, adhesive bonding, brazing, and pressing.

8. The method as claimed in claim 5, further comprising setting the spacing with a gauge.

9. The method as claimed in claim 5, further comprising forming at least one of the first stop element or the second stop element by injection-molding a metal.
